(19) United States
(12) Patent Application Publication
(10) Pub. No.: US 2006/0213380 A1
(43) Pub. Date: Sep. 28, 2006

(54) Displaceable tampon support of a tampon printing machine

(75) Inventor: Holger Reinholdt, Freudenstadt (DE)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW MORLOCK GMBH, DORNSTETTEN (DE)

(21) Appl. No.: 10/555,983

(22) PCT Filed: Jun. 20, 2003
(86) PCT No.: PCT/EP03/06519

§ 371 Date: Nov. 8, 2005

(51) Int. Cl. B41F 17/00

(52) U.S. Cl. 101/41

(57) ABSTRACT

The invention relates to a pad printing machine comprising a transfer pad carrier (22) which is displaceable not only up and down in a first y-direction (24) but also forward and backward in an x-direction (38). The design of the invention allows using one type of printing machines for a plurality of purposes.

The present invention relates to a pad printing machine to print items using a transfer pad in the manner defined in the preamble of claim 1.

A pad printing machine of this kind is known from U.S. Pat. No. 5,662,041. The transfer pad is a resilient stamp.

A pad printing machine may be designed for fully automated or for manual operation. If operation is automated, the displacement range of the transfer pad carrier and of the cliché plate support preferably is screened so as to preclude a human hand becoming wedged between said carrier on one hand and an item support on the other. When pad printing machines are designed for manual operation, entailing manually inserting into and removing from the machine the items being printed, two-hand operation is used for safety, whereby the pad printing machine can be switched ON when two mutually spaced apart operating elements are being operated simultaneously using both hands.

The objective of the present invention is to design a pad printing machine of the above kind in a manner to much expand its versatility without thereby incurring costly steps in construction.

This problem is solved by the features of claim 1 of the present invention.

Accordingly the present invention relates to a pad printing machine containing a cliché plate support which together with a cliché plate resting on it is displaceable, forward and backward, along a first x-line between an ink collecting position and an ink delivery position, relative to an ink cup in a first guide, the ink cup sliding on the surface of the cliché plate and being open toward the cliché plate surface, at least one printed image recess being made in the cliché plate surface and, when in the ink collecting position, being situated underneath the ink cup and in the ink delivery position being positioned beyond the first guide; further the present invention relates to a transfer pad carrier displaceable up and down in a second guide along a first y-line, which is transverse to the first x-line, between an upper rest position and a lower cliché plate contact position when the cliché plate support is in the ink delivery position to collect printing ink from the printing image recess of the cliché plate by means of the transfer pad carried by the transfer pad carrier; where the transfer pad carrier, after it has been moved upward again from the cliché plate contact position, again is displaceable downward along the first y-line into a printing position; to drive elements displacing the cliché plate support and the transfer pad carrier, characterized in that when it is at a level higher than when it is in the cliché plate contact position, the transfer pad carrier is displaceable forward and backward perpendicularly to first y-line between the first y-line and a second y-line along a second y-line in a third guide, the second y-line running transversely to the two x-lines and being farther forward from the first guide of the cliché plate support than is the first y-line.

The pad printing machine of an especially preferred embodiment of the present invention is characterized further in that the transfer pad carrier together with the transfer pad is displaceable up and down along the second y-line between the first level and a lower second level.

### ADVANTAGES OF THE INVENTION

Items to be printed may be manually held on an item support in the second y-line without incurring the danger of the operator's or others' hand(s) getting wedged between the item support on one hand and the cliché plate or a cliché plate support on the other. Items may be printed in the second y-line that are substantially wider than items in the first y-line because the second y-line is farther forward from the cliché plate support than is the first y-line. Moreover it is feasible to print an item extending transversely over both y-lines simultaneously in both y-lines. Again there is the feasibility to print one item in the first y-line while simultaneously printing another item in the second y-line, as a result of which twice as many items may be printed per unit time using a single pad printing machine than can be with the known pad printing machines of comparable kinds. The invention offers the further possibility to configure a cleaning element in the second y-line to clean the transfer pad in order to avert loss of item position on the item support by using in said first y-line a cleaning device cleaning the transfer pad. The cleaning element may be configured in the second y-line at the first level of the transfer pad carrier in order to make contact there with the transfer pad, or to configure it at a lower site, for instance on an item support in order to contact the transfer pad there and to clean it. The item support may be designed to move only one item or to simultaneously move several items which are moved by the item support sequentially into the first y-line (or into the second y-line or both y-lines). Illustratively the item support may be linearly displaceable or be like a turntable.

It is understood therefore that by means of a single design of pad printing machines, the invention enables forming a large number of different pad printing machine work stations.

The dependent claims define further features of the invention. Such features offer the advantages of being operationally reliable and of especially simple design.

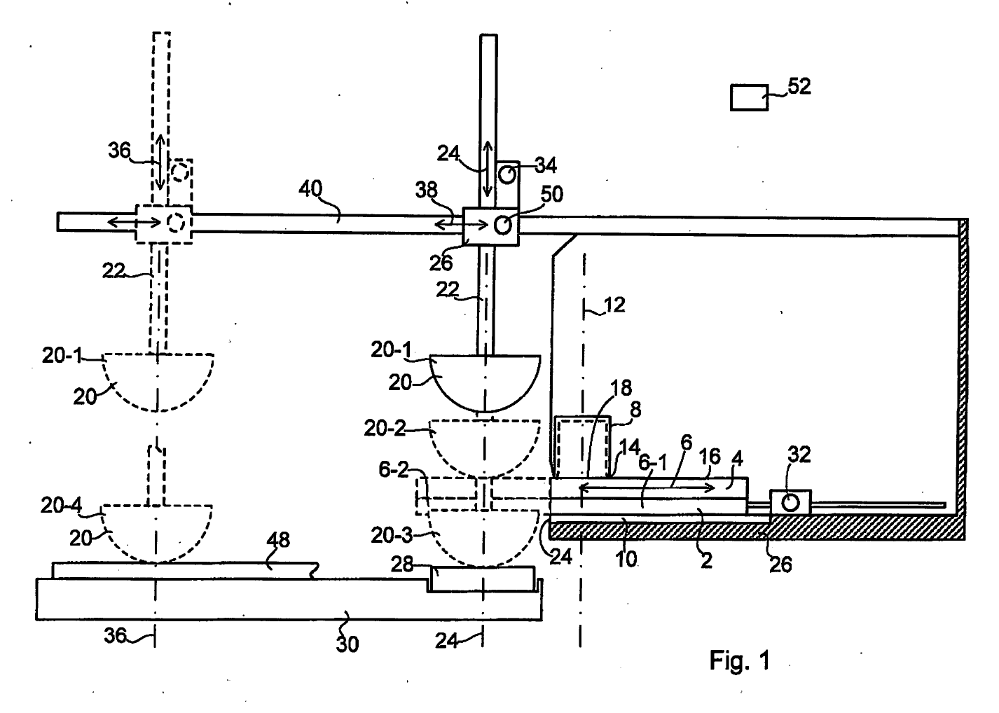

The invention is elucidated below in relation to the appended FIG. 1 and an illustrative preferred embodiment.

FIG. 1 shows the preferred embodiment of a pad printing machine of the invention in merely schematic manner.

The pad printing machine of the invention comprises a cliché plate support 2 which jointly with the cliché plate 4 it bears is displaceable forward and back, as indicated by the double-arrow first x-line 6, in a first guide 10, between an ink collecting position 6-1 shown in solid lines and an ink delivery position 6-2 shown in dashed lines, relative to an ink cup 8.

The ink cup 8 is held in place by an omitted holder element in a defined cup position 12 indicated by a vertical, dash-dot line. When moving back and forth the cliché plate 4 by means of the cliché plate support 2 along the first x-line 6, the lower edge 14—designed as a doctor blade—of the cup 8 slides on the surface 16 of the cliché plate 4. The ink cup 8 is open at its lower side toward the surface 16 of the cliché plate 4, whereby the ink present in the printing cup 8 rests on the surface 16 of the cliché plate 4 and may enter a printing image 18 constituted in the surface 16 of the cliché plate 4 by at least one print image recess. The printing image recess 18 is situated within the inner periphery of the ink cup 8 when the cliché plate 4 is in its ink collecting position 6-1. When in its ink delivery position 6-2, the printing image recess is situated underneath a transfer pad 20 supported by a transfer pad carrier 22.

When in the ink collecting position 6-1, the fore edges of the cliché plate support 2 and of the cliché plate 4 are situated approximately in the same vertical plane or only shortly before or shortly behind, as is the fore edge 24 of the first guide 10. The front edge of a printing machine base 26 bearing the first guide or constitutes same is situated approximately in the same vertical plane as the fore edge 24 of the first guide 10.

The transfer pad 22 is displaceable up and down perpendicularly to the first x-line 6, which is indicated by a horizontal double arrow, in a second guide 26 along a first y-line 24 indicated by a vertical double arrow, namely between an upper rest position 20-1, and a lower cliché plate contact position 20-2 when the cliché plate support 2 is in the ink delivery position 6-2 in order to pick up ink, by means of the transfer pad 20 supported by the transfer pad carrier 22, out of the printing image recess 18 of the cliché plate 4.

The transfer pad carrier 22 together with the transfer pad 20 is again displaceable upward, after the ink was picked up at the ink image recess 18 of the cliché plate 4, as high as an intermediate position or preferably as high as the rest position 20-2, so that it shall release the cliché plate 4 in order that the cliché plate support 2 together with the cliché plate 4 may be moved back from the ink delivery position 6-2 into the ink pickup position 6-1. This procedure allows a vertical displacement path in front of the fore edge 24 of the first guide 10, the transfer pad carrier 22 together with the transfer pad 20 being again displaceable downward in said vertical displacement path along the first y-line 24 into a printing position 20-3 in order to print the ink of the transfer pad 20 onto an item 28. The item 28 rests on an item support 30 and is kept in a predetermined position.

The printing position 20-3 may be at any arbitrary height below the rest position 20-1, though preferably it shall be below the cliché plate contact position 20-2 in order that the transfer pad 20 may be able to print the item 28 without thereby having to move the support 30 up and down.

The item support 30 may be designed in a variety of ways, for instance to support only one item 28 or several items 28, this item support 30 being linearly displaceable in a horizontal plane or being rotatable about an axis of rotation and the items 28 on the item support 30 being sequentially arrayed in its direction of motion, whereby each time one item 28 may be sequentially positioned in the first y-line 24 underneath the transfer pad in order to be printed.

The ink transferred by the transfer pad 20 onto the item 28 is in the form of a script and/or an image and/or a symbol and/or another marking corresponding to the print image recess 18 of the cliché plate 4.

The drives displacing the cliché plate carrier 2 and the transfer pad carrier 22 are shown schematically in FIG. 1 as an adjustment motor 32 to advance/retract the cliché plate support along the first x-line 6 and an adjustment motor 34 to move the transfer pad carrier 22 up and down along the first y-line 24. The adjustment drives 32 and 34 may be electrical, pneumatic or hydraulic.

At a first level where it is higher than when in the cliché plate contact position 20-2, the transfer pad carrier 22 is displaceable transversely to the first y-line 24 between latter and a second y-line 36 and forward and backward along a second x-line 38 in a third guide 40. The first level, at which the transfer pad carrier 22 together with the transfer pad 20 is displaceable forward and backward along the second x-line 40, may be located at an arbitrary height between the cliché plate contact position 20-2 and the upper rest position 2-1, however in the preferred embodiment mode said first level shall be the upper rest position 20-1.

According to said preferred embodiment mode, the second guide 26 relative to which the transfer pad carrier 22 together with the transfer pad 20 is vertically displaceable, is mounted in such manner to the third guide 40 as to be displaceable forward and backward at the third guide 40 along the x-line 38. Illustratively the second guide 26 may be a slide or a carriage resting on the third guide 40. However and in another embodiment, the second guide 26 and the third guide 40 also may be mutually displaceable rails or be designed in other manner.

The transfer pad carrier 22 together with the transfer pad 20 is displaceable vertically along the second y-line 36 between the first level—which preferably is the level of the rest position 20-1—and a second lower level 204 in the manner schematically shown by dashed lines in FIG. 1. The second level 20-4 may be same as the cliché plate contact position 20-2 or the printing position 20-3 or it may be another height.

The second y-line 36 runs perpendicularly to the two x-lines 6 and 38 and is farther away forward from the fore edge 24 of the first guide 10 of the cliché plate carrier 2 and the fore edge of the machine base 26 than is the first y-line 24.

When the transfer pad carrier 22 together with the transfer pad 20 is situated in the second y-line 36, the transfer pad 20 is more easily exchanged than in the first y-line 24 because the larger distance between the fore edge 24 of the first guide 10 and the printing machine base 26 subtends more space. Moreover a cleaning element to clean the transfer pad may 20 be may be inserted in the second y-line 36, where, depending on the design and selected position of the cleaning element the transfer pad may be cleaned at the first level 20-1 or at the second level 204. Cleaning the transfer pad in the second y-line 36 offers the advantage of more available space than when in the first y-line 24 and that furthermore no space shall be lost for a cleaning element on the item support 30 for printing the items 28.

Further advantages accrue when the transfer pad carrier 22 together with the transfer pad 20 is displaceable not only forward from the first y-line 24 to the second y-line 36 but also up and down along the second y-line 36 between the upper first level 20-1—which preferably shall be the upper rest position—and the lower second level 204, namely the transfer pad 20 will be more easily exchanged and cleaned than at the first level 20-1. This design makes it possible to manually keep in place other items 48 or the same items 28 on the same or on another support 30 for the printing procedure without running the danger of injury due to wedging a hand or a finger between the item support 30 and the displaceable cliché plate carrier 2. Because of the larger space between the fore edge 24 of the first guide 10 and the printing machine base 26, bigger items 48 may be printed. It is possible furthermore to print, by means of the transfer pad 20, large items 48 extending across both y-lines 24 and 36. Another possibility is to use the transfer pad 20 to print two separate products 28 in the first y-line 24 and in the second y-line 36 without the item support 30 being required to carry out a transport motion, i.e moving a printed item 28 out and moving a new item 28 in.

In a preferred embodiment of the invention, two separate item supports are NOT configured at the two y-lines 24 and 36, but instead a single item support 30 is, which extends across both y-lines 24 and 36 as shown in FIG. 1.

Accordingly the material present at the lower level 20-4 in the second y-line 36 may be either an item 28, 24 to be printed or a cleaning element to clean the transfer pad 20.

In the preferred embodiment of the invention, the first x-line 6 and the second x-line 38 are mutually parallel. Preferably the second y-line 36 shall be parallel to the first y-line 24. Preferably furthermore at least one, even more preferred all the x and/or y-lines 6, 38, 24, 36 shall be rectilinear. Again in a preferred embodiment, the y-lines 24 and 36 are orthogonal to the x-lines 6 and 38. Also preferred are the designs whereby the x-lines 6 and 38 shall be horizontal and the y-lines 24 and 36 shall be vertical. The expert understands that deviations from these preferred embodiment modes are allowed.

In another preferred embodiment of the invention, the second level 20-4, to which the transfer pad carrier 22 may be lowered, is adjustable in height to match various operational conditions, for instance being matched to items 48 of varying heights or to various applications such as cleaning the transfer pad 20 instead of printing ink from the transfer pad 20 onto an item 48.

A schematically indicated adjustment drive element 50 which may be electrical, pneumatic of hydraulic moves the transfer pad carrier 22 along the second x-line 38.

The drive elements 32, 34 and 50 preferably are actuated by an electronic control unit 52 as a function of a predetermined printing procedure to sequentially print a plurality of items 28 (and/or 48; preferably also to clean the transfer pad 20). For that purpose the control unit 52 preferably contains an automated program.

The cliché plate 2 may be constituted in all embodiments by the cliché plate support itself instead of being an element apart. In that case a top surface of the cliché plate support 4 is designed as cliché plate surface 16 containing at least one printing image recess 18.

1. A pad printing machine comprising a cliché plate support which, together with a cliché plate it bears, is displaceable forward and backward in a first x-line between an ink pickup position and an ink delivery position, relative to an ink cup, in a first guide, the ink cup sliding on the surface of the cliché plate and being open toward the surface of the cliché plate, and where at least one printing image recess is present in the surface of the cliché plate and in the ink pickup positions, will be positioned underneath the ink cup and in the ink delivery position will be positioned beyond the first guide; a transfer pad carrier which is displaceable up and down along a first y-line that is perpendicular to the first x-line between an up-per rest position and a lower cliché plate contact position in a second guide when the cliché plate support is in the ink delivery position in order to pick up, by a transfer pad borne by the transfer pad carrier ink from the printing image recess of the cliché plate; where the transfer pad carrier after having been moved upward again from the cliché plate contact position is moved back again from the ink delivery position into the ink pickup position is downwardly displaceable again along the first y-line into a printing position; drive elements to move the cliché plate support and the transfer pad carrier,
wherein
the transfer pad carrier is displaceable forward and backward, at a first level at which it is configured higher than when being in the cliché plate contact position, transversely to the first y-line between latter and a second y-line along a second x-line in a third guide, where the second y-line runs perpendicularly to the two x-lines and is situated farther forward from the first guide of the cliché plate support than is the first y-line.

2. Pad printing machine as claimed in claim 1, wherein the transverse pad carrier together with the transverse pad is displaceable up and down in the second y-line along same and between the first level and a lower second level.

3. Pad printing machine as claimed in claim 1, wherein the transfer pad carrier is in the rest position at the said first level.

4. Pad printing machine as claimed in claim 2, wherein the second level of the transfer pad carrier is the same level as that assumed by said transfer pad carrier in the cliché plate contact position.

5. Pad printing machine as claimed in claim 2, wherein the second level of the transfer pad carrier is higher than the level assumed by the transfer pad carrier in the cliché plate contact position.

6. Pad printing machine as claimed in claim 2, wherein the second level of the transfer pad carrier is lower than the level assumed by the transfer pad carrier in the cliché plate contact position.

7. Pad printing machine as claimed in claim 2, wherein the second level to which the transfer pad carrier may be moved is adjustable in height.

8. Pad printing machine as claimed in claim 1, wherein an item support which keeps the items to be printed in the printing position so they may printed with ink by the transfer pad of the transfer pad carrier in said printing position runs transversely across both y-lines and is designed to receive an item which can be contacted by a transfer pad of the transfer pad carrier in the second y-line.

9. Pad printing machine as claimed in claim 1, wherein the second x-line runs parallel to the first x-line.

10. Pad printing machine as claimed in claim 1, wherein the second y-line is parallel to the first y-line.

11. Pad printing machine as claimed in claim 1, wherein at least one of the x-lines and/or y-lines is rectilinear.

12. Pad printing machine as claimed in claim 11, wherein the y-lines are orthogonal to the x-lines.
